(19) United States
(12) Patent Application Publication
(10) Pub. No.: US 2026/0291944 A1
(43) Pub. Date: Sep. 24, 2026

(54) METHODS, SYSTEMS, AND COMPUTER READABLE MEDIA FOR SERVICE COMMUNICATION PROXY (SCP)-ENFORCED NETWORK FUNCTION (NF)-SECURITY-GROUP-BASED NETWORK SEGREGATION

(71) Applicant: Oracle International Corporation, Redwood Shores, CA (US)

(72) Inventors: Jay Rajput, Bangalore (IN); Virendra Singh, Bangalore (IN); Ashish Kumar, Gurgaon (IN); Shashikiran Bhalachandra Mahalank, Bangalore (IN)

(21) Appl. No.: 19/691,045

(22) Filed: May 28, 2026

(51) Int. Cl. H04L 9/40

(52) U.S. Cl. CPC H04L 63/104; H04L 63/0823; H04L 63/166

(57) ABSTRACT

Methods, systems, and computer readable media for service communication proxy (SCP)-enforced network function (NF)-security-group-based segregation are disclosed. In one example, an SCP conducts security handshakes with NFs and learns, from the security handshakes, security groups of the NFs. Based on the learning, the SCP populates an NF security group database accessible by the SCP and including records identifying security groups of the NFs. The SCP receives service-based interface (SBI) messages transmitted by the NFs and uses the NF security group database to perform security-group-based segregation of the SBI messages, including selectively forwarding or blocking SBI messages based on whether a sender NF and a target NF are members of the same security group or mutually trusted security groups.

### TECHNICAL FIELD

The subject matter described herein relates to security in a communication network. More particularly, the subject matter described herein relates to methods, systems, and computer readable media for SCP-enforced NF-security-group-based network segregation.

### BACKGROUND

In 5G telecommunications networks, a network function that provides service is referred to as a producer NF or NF service producer. A network function that consumes services is referred to as a consumer NF or NF service consumer. A network function can be a producer NF, a consumer NF, or both, depending on whether the network function is consuming, producing, or consuming and producing services. The terms “producer NF” and “NF service producer” are used interchangeably herein. Similarly, the terms “consumer NF” and “NF service consumer” are used interchangeably herein.

A given producer NF may have many service endpoints, where a service endpoint is the point of contact for one or more NF instances hosted by the producer NF. The service endpoint is identified by a combination of Internet protocol (IP) address and port number or a fully qualified domain name (FQDN) that resolves to an IP address and port number on a network node that hosts a producer NF. An NF service instance is an instance of a producer NF that provides a service. A given producer NF instance may include more than one NF service instance if the producer NF instance provides multiple services. It should also be noted that multiple producer NF instances can share the same service endpoint.

NFs register with an NF repository function (NRF). The NRF maintains profiles of available NF instances identifying the services supported by each NF instance. The profile of an NF instance is referred to in Third Generation Partnership Project (3GPP) Technical Specification (TS) 29.510 as an NF profile. NF instances can obtain information about other NF instances that have registered with the NRF through the NF discovery service operation. According to the NF discovery service operation, a consumer NF sends an NF discovery request to the NRF. The NF discovery request includes query parameters that the NRF uses to locate the NF profiles of producer NFs capable of providing the service identified by the query parameters. NF profiles are data structures that define the type of service provided by an NF instance as well as contact and capacity information regarding the NF instance.

A service communication proxy (SCP) can also invoke the NF discovery service operation to learn about available producer NF instances. The case where the SCP uses the NF discovery service operation to obtain information about producer NF instances on behalf of consumer NFs is referred to as delegated discovery. Consumer NFs connect to the SCP, and the SCP load balances traffic among producer NF service instances that provide the required services or directly routes the traffic to the destination producer NF instances.

One problem with networks that include SCPs for indirect communications between NFs is that existing point-to-point security mechanisms do not provide end-to-end security for communications between endpoints. For example, transport layer security (TLS) provides for secure communication between directly connected communication endpoints. However, if the endpoints are NFs connected indirectly via an SCP, TLS does not prevent one endpoint that is not authorized to communicate with another endpoint from sending a message to the other endpoint via an SCP. While the OAuth 2.0 access token security mechanism is used in some networks, not all networks support access-token-based authorization.

Accordingly, in light of these and other difficulties, there exists a need for providing secure communication between endpoints in networks that support indirect communication via an SCP.

### SUMMARY

A method for service communication proxy (SCP)-enforced network function (NF)-security-group-based network segregation includes conducting, by an SCP, security handshakes with NFs. The method further includes learning, by the SCP and from the security handshakes, security groups of the NFs. The method further includes populating, based on the learning, an NF security group database accessible by the SCP and including records identifying security groups of the NFs. The method further includes receiving, by the SCP, service-based interface (SBI) messages transmitted by the NFs. The method further includes using, by the SCP, the NF security group database, to perform security-group-based segregation of the SBI messages transmitted by the NFs.

According to another aspect of the subject matter described herein, conducting the security handshakes with the NFs includes conducting transport layer security (TLS) security handshakes with the NFs.

According to another aspect of the subject matter described herein, learning security groups of the NFs includes reading, from TLS Certificate messages transmitted by the NFs, client certificate issuer certificate authority (CA) identifiers and reading, certificate_authorities extensions of TLS ClientHello messages transmitted by the NFs, lists of identifiers of certificate authorities trusted by the NFs.

According to another aspect of the subject matter described herein, populating the security group database comprises including, in each record of the NF security group database, an identifier of a client certificate issuer CA and identifiers of CAs trusted by the NFs.

According to another aspect of the subject matter described herein, populating the security group database includes automatically populating the security group database by the SCP.

According to another aspect of the subject matter described herein, populating the security group database includes manually populating the security group database through a configuration interface of the SCP.

According to another aspect of the subject matter described herein, using the NF security group database to perform security-group-based segregation of the SBI messages transmitted by the NFs includes: receiving an SBI message; determining a client certificate issuer certificate authority (CA) identifier of a sender of the SBI message and a client certificate issuer CA identifier of a target of the SBI message; and using the client certificate issuer CA identifier of the sender or the client certificate issuer CA of the target to locate a record in the security group database; and determining, using the record, whether the sender and the target are members of the same NF security group.

According to another aspect of the subject matter described herein, the method for SCP-enforced NF-security-group-based network segregation comprises, in response to determining that the sender and the target are members of the same NF security group, forwarding the SBI message to the target.

According to another aspect of the subject matter described herein, the method for SCP-enforced NF-security-group-based network segregation comprises, in response to determining that the sender and the target are not members of the same NF security group, blocking the SBI message.

According to another aspect of the subject matter described herein, the method for SCP-enforced NF-security-group-based segregation comprises, in response to determining that the sender and the target are not members of the same NF security group but are members of mutually trusted security groups, forwarding the SBI message.

According to another aspect of the subject matter described herein, a system for service communication proxy (SCP)-enforced network function (NF)-security-group-based network segregation is provided. The system includes an SCP including at least one processor and memory. The system further includes an NF security group manager stored in the memory and executable by the at least one processor for learning, from security handshakes between the SCP and NFs, security groups of the NFs; populating, based on the learning, an NF security group database accessible by the SCP and including records identifying security groups of the NFs; receiving service-based interface (SBI) messages transmitted by the NFs; and using the NF security group database to perform security-group-based segregation of the SBI messages transmitted by the NFs.

According to another aspect of the subject matter described herein, the security handshakes comprise transport layer security (TLS) security handshakes.

According to another aspect of the subject matter described herein, the NF security group manager is configured to learn the NF security groups of the NFs by reading, from TLS Certificate messages transmitted by the NFs, client certificate issuer certificate authority (CA) identifiers and reading, from certificate_authorities extensions of TLS ClientHello messages transmitted by the NFs, lists of certificate authorities trusted by the NFs.

According to another aspect of the subject matter described herein, the NF security group manager is configured to include, in each record of the NF security group database, an identifier of a client certificate issuer CA and identifiers of CAs trusted by the NF.

According to another aspect of the subject matter described herein, the NF security group manager is configured to automatically populate the NF security group database.

According to another aspect of the subject matter described herein, the SCP includes a configuration interface for manually populating the NF security group database.

According to another aspect of the subject matter described herein, the NF security group manager is configured to use the NF security group database to perform security-group-based segregation of the SBI messages transmitted by the NFs by: receiving an SBI message; determining a client certificate issuer certificate authority (CA) identifier of a sender of the SBI message and a client certificate issuer CA identifier of a target of the SBI message; using the client certificate issuer CA identifier of the sender or the client certificate issuer CA identifier of the target to locate a record in the NF security group database; and determining, using the record, whether the sender and the target are members of the same NF security group.

According to another aspect of the subject matter described herein, the NF security group manager is configured to, in response to determining that the sender and the target are members of the same NF security group, cause the SCP to forward the SBI message to the target.

According to another aspect of the subject matter described herein, the NF security group manager is configured to, in response to determining that the sender and the target are not members of the same NF security group, cause the SCP to block the SBI message.

According to another aspect of the subject matter described herein, a non-transitory computer readable medium having stored thereon computer executable instructions that, when executed by at least one processor of a service communication proxy (SCP), cause the SCP to perform steps is provided. The steps include conducting security handshakes with network functions (NFs); learning, from the security handshakes, security groups of the NFs; populating, based on the learning, an NF security group database accessible by the SCP and including records identifying security groups of the NFs; receiving service-based interface (SBI) messages transmitted by the NFs; and using the NF security group database to perform security-group-based segregation of the SBI messages transmitted by the NFs.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Exemplary implementations of the subject matter described herein will now be explained with reference to the accompanying drawings, of which:

FIG. 1 is a network diagram illustrating an exemplary 5G system network architecture;

FIG. 2 is a network diagram illustrating an example deployment in which an SCP provides indirect communication among network functions (NFs) in multiple NF security groups;

FIG. 3 is a message flow diagram illustrating an example full transport layer security (TLS) handshake and example exchange of certificate information and TLS extensions;

FIG. 4 is a message sequence diagram illustrating a problem scenario in which indirect routing via an SCP allows an SBI request from a first NF in a first group to reach an NF in a different group;

FIG. 5 is a message sequence diagram illustrating an example solution in which an SCP assigns NFs to NF security groups based on certificate authority information and selectively forwards or blocks SBI messages based on the NF security groups;

FIG. 6 is a block diagram illustrating an example architecture of an SCP for enforcing NF-security-group-based network segregation; and

FIG. 7 is a flow chart illustrating an example process for SCP-enforced NF-security-group-based network segregation.

### DETAILED DESCRIPTION

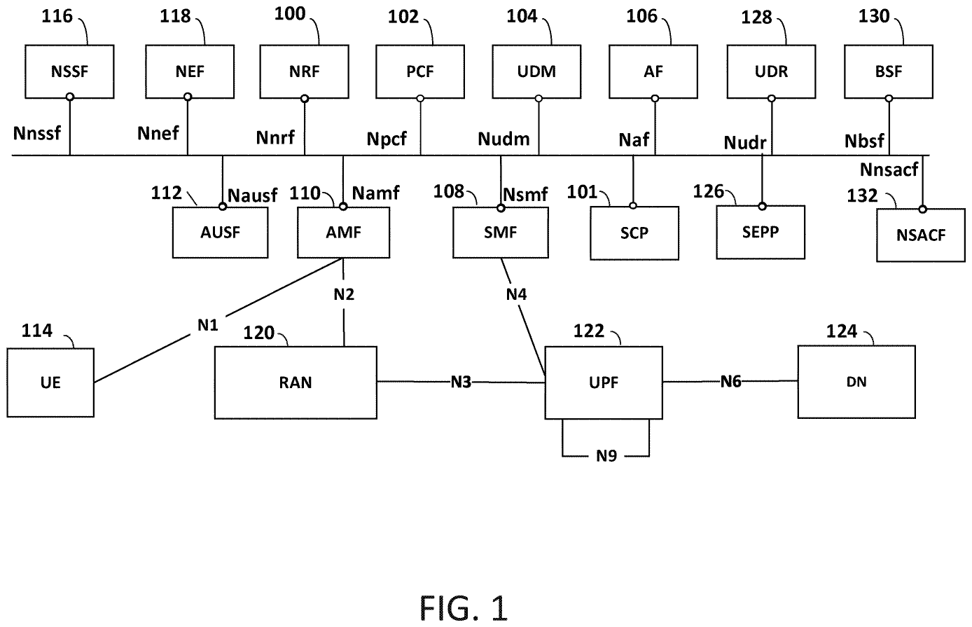

FIG. 1 is a block diagram illustrating an exemplary 5G system network architecture. The architecture in FIG. 1 includes NRF 100 and SCP 101, which may be located in the same public land mobile network (PLMN). As described above, NRF 100 may maintain profiles of available NF instances and their supported services and allow consumer NFs or SCPs to subscribe to and be notified of the registration of new/updated NF instances. SCP 101 may also support service discovery and selection of NF instances. SCP 101 may perform load balancing of connections between consumer and producer NFs.

NRF 100 is a repository for profiles of NF instances. To communicate with a producer NF instance, a consumer NF or an SCP must obtain the NF profile of the producer NF instance from NRF 100. The NF profile is a JavaScript object notation (JSON) data structure defined in 3GPP TS 29.510. The NF profile includes attributes that indicate the type of service provided, capacity of the NF instance, and information for contacting the NF instance.

In FIG. 1, any of the network functions can be consumer NFs, producer NFs, or both, depending on whether they are requesting, providing, or requesting and providing services. In the illustrated example, the NFs include policy control function (PCF) 102 that performs policy related operations in a network, unified data management (UDM) function 104 that manages user and policy data, and an application function (AF) 106 that provides application services.

The NFs illustrated in FIG. 1 further include a session management function (SMF) 108 that manages sessions between an access and mobility management function (AMF) 110 and PCF 102. AMF 110 performs mobility management operations similar to those performed by a mobility management entity (MME) in 4G networks. An authentication server function (AUSF) 112 performs authentication services for user equipment (UEs), such as user equipment (UE) 114, seeking access to the network.

A network slice selection function (NSSF) 116 provides network slicing services for devices seeking to access specific network capabilities and characteristics associated with a network slice. NSSF 116 provides the NSSelection service, which allows NFs to request information about network slices and the NSSAIReachability service, which enables NFs to update and subscribe to receive notification of updates in network slice selection assistance information (NSSAI) reachability information.

A network exposure function (NEF) 118 provides application programming interfaces (APIs) for application functions seeking to obtain information about Internet of things (IoT) devices and other UEs attached to the network. NEF 118 performs similar functions to the service capability exposure function (SCEF) in 4G networks.

A radio access network (RAN) 120 connects user equipment (UE) 114 to the network via a wireless link. Radio access network 120 may be accessed using a gNodeB (gNB) (not shown in FIG. 1) or other wireless access point. A user plane function (UPF) 122 can support various proxy functionality for user plane services. One example of such proxy functionality is multipath transmission control protocol (MPTCP) proxy functionality. UPF 122 may also support performance measurement functionality, which may be used by UE 114 to obtain network performance measurements. Also illustrated in FIG. 1 is a data network (DN) 124 through which UEs access data network services, such as Internet services.

A security edge protection proxy (SEPP) 126 filters incoming traffic from another PLMN and performs topology hiding for traffic exiting the home PLMN. SEPP 126 may communicate with a SEPP in a foreign PLMN which manages security for the foreign PLMN. Thus, traffic between NFs in different PLMNs may traverse two SEPP functions, one for the home PLMN and the other for the foreign PLMN. Unified data repository (UDR) 128 stores subscription data for UEs. A binding support function (BSF) 130 manages bindings between packet data unit (PDU) sessions and PCFs. A network slice admission control function (NSACF) 132 performs network slice admission control operations to ensure that network slices are not overburdened by UEs or PDU sessions.

As indicated above, one problem that exists in networks that support indirect communications via an SCP is providing security between non-directly connected endpoints. 5G customers have a need for network segregation, i.e., a group of NFs that can only communicate with other NFs within the group and not outside of the group. Network segregation helps with multiple cases, one being the deployment of mobile virtual network operator (MVNO) NFs in the customer network. Traditional network segregation mechanisms using IP-level restriction or TLS verification do not work for 5G networks due to multiple reasons; one reason is the fact that the IP/TLS connection is not end-to-end between consumer and producer NFs.

The subject matter described herein includes an application-level solution (rather than an IP- or TLS-level solution) at the SCP, where the SCP automatically assigns a security group to an NF and then allows communication only within the group. In one example, automatic assignment by the SCP is performed using the TLS certificate issuer, i.e., the certificate authority. All NFs using the same issuer CA are assigned to the same group. Communication between an NF consumer and an NF producer is allowed only when they belong to the same group. In addition, NFs can trust (or not trust) NFs assigned to other CAs, such that NFs assigned to one CA can communicate with NFs assigned to other CAs when the CAs form a trusted CA group.

As indicated above, the OAuth 2.0 access token mechanism addresses this issue, but not all customers have enabled OAuth 2.0 authentication due to performance and configuration overhead.

### Indirect Communication Using an SCP

3GPP TS 29.500 section 6.10 explains indirect communication using an SCP. The point to highlight is that there is a unique IP/TLS connection between each NF and the SCP, i.e., consumer NF to SCP and SCP to producer NF are different connections. In other words, there is no end-to-end connection between a consumer NF and a producer NF, due to which IP- or

### TLS-Level Security Mechanisms are not Sufficient.

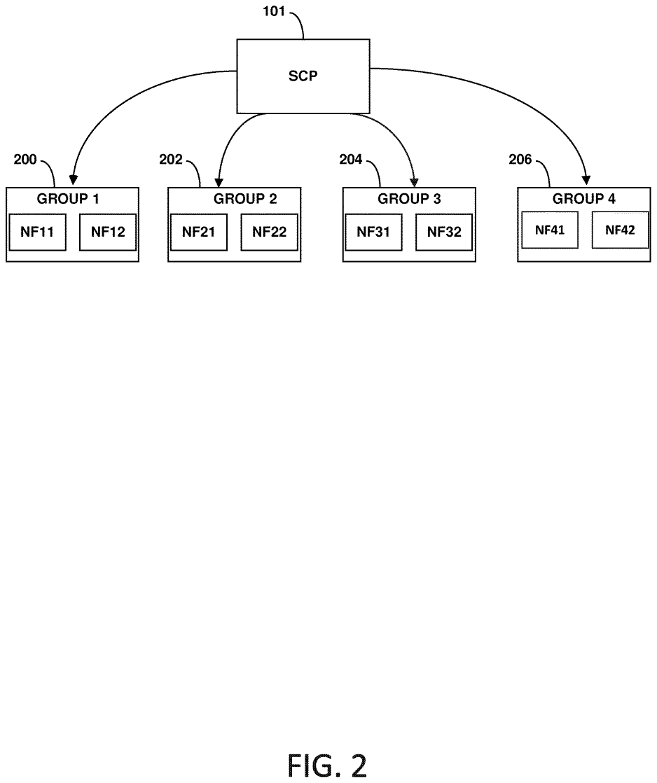

Table 1 shown below and FIG. 2 illustrate an example deployment showing NFs in different groups. In FIG. 2, SCP 101 provides for indirect communication among NFs within each group. NFs in group 1 200 should be able to communicate with other NFs in group 1 200. NFs in group 2 202 should be able to communicate with other NFs in group 2 202. NFs in group 3 204 should be able to communicate with other NFs in group 3 204. NFs in group 4 206 should be able to communicate with other NFs in group 4 206. However, unless there is trust among groups, NFs in each group should not be able to communicate with NFs in other groups.

Each group has NFs with a TLS certificate issued by the same CA. Each group has a unique CA. Each group trusts its group and SCP 101. SCP 101 trusts all groups. Table 1 shows the mappings between client certificate issuer CAs, trusted CAs, and NFs.

TABLE 1
Example NF Groupings

| NFs | Issuer CA | Trusted CAs |
|---|---|---|
| NF11, NF12 | CA1 | CA1, CA5 |
| NF21, NF22 | CA2 | CA2, CA5 |
| NF31, NF32 | CA3 | CA3, CA5 |
| NF41, NF42 | CA4 | CA4, CA5 |
| SCP | CA5 | ALL |

### IP-Based Restriction

IP firewalls can be configured based on the source IP. This solution is limited to networks where the source IP is known. Due to the cloud-native nature of 5G, the source IP is never known/fixed. Cloud-native environments like Kubernetes (K8s) require a flat network for communication between two pods in the K8s network. This flat-network requirement is supported by network plugins like Calico, Flannel, etc., where they either encapsulate or decapsulate the packet, which makes IP-based restriction impractical. Further, pod IP addresses are ephemeral, as the pod itself is ephemeral. Compare this to a traditional virtual machine or bare-metal network where machines can reboot but will come up with a well-defined IP address.

### TLS-Based Restriction

A TLS certificate is used as an NF identity. TLS also includes a concept of a trust store where an NF can choose to define the CAs that it trusts, i.e., an NF will talk only to another NF for which the issuer CA is in the trust store. This solution is limited to direct communication requiring an end-to-end connection between two NFs, which is not true for indirect communication via an SCP in 5G networks.

### TLS Handshake

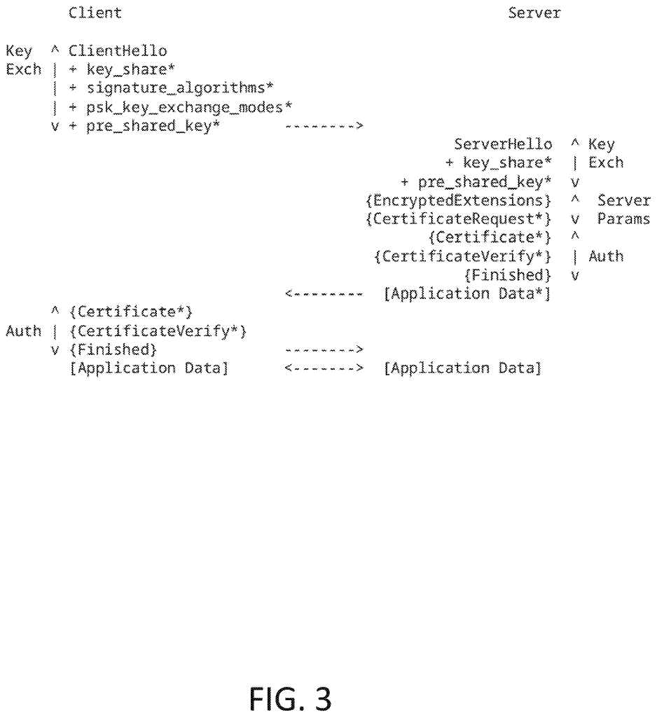

RFC 8446 section 2 (Protocol Overview), FIG. 1, a copy of which is reproduced herein as FIG. 3, shows a basic full TLS handshake. The intent here is to highlight that the TLS certificate and extensions are shared in the TLS handshake.

### TLS Certificate Authorities Extension

RFC 8446 section 4.2.4 (Certificate Authorities) defines the Certificate Authorities extension. Quoting from the RFC, the point to highlight is that by using the certificate_authorities extension one can discover the list of trusted CAs:
The “certificate_authorities” extension is used to indicate the certificate authorities (CAs) which an endpoint supports and which SHOULD be used by the receiving endpoint to guide certificate selection.
. . .
authorities: A list of the distinguished names [X501] of acceptable certificate authorities, represented in DER-encoded [X690] format. These distinguished names specify a desired distinguished name for a trust anchor or subordinate CA; thus, this message can be used to describe known trust anchors as well as a desired authorization space.
. . .

### Problem Statement

5G network users have a need for network segregation, i.e., a group of NFs can only talk within the group and not outside the group. Network segregation helps with multiple cases, one being the deployment of MVNO NFs in the customer network. Traditional network segregation mechanisms using IP-level restriction or TLS verification do not work for 5G networks due to multiple reasons; one reason is the fact that the connection is not end-to-end between a consumer and a producer NF.

IP-level restriction is not feasible due to the cloud-native nature of 5G, which requires NAT (needed for K8s pod communication) and dynamic IP allocation (K8s pod IP is ephemeral), and due to the need for indirect communication using an SCP where the IP connection is not end-to-end.

TLS-based restriction also cannot be used, as the connection between an NF consumer and an NF producer is not end-to-end in 5G networks using an SCP for indirect communication.

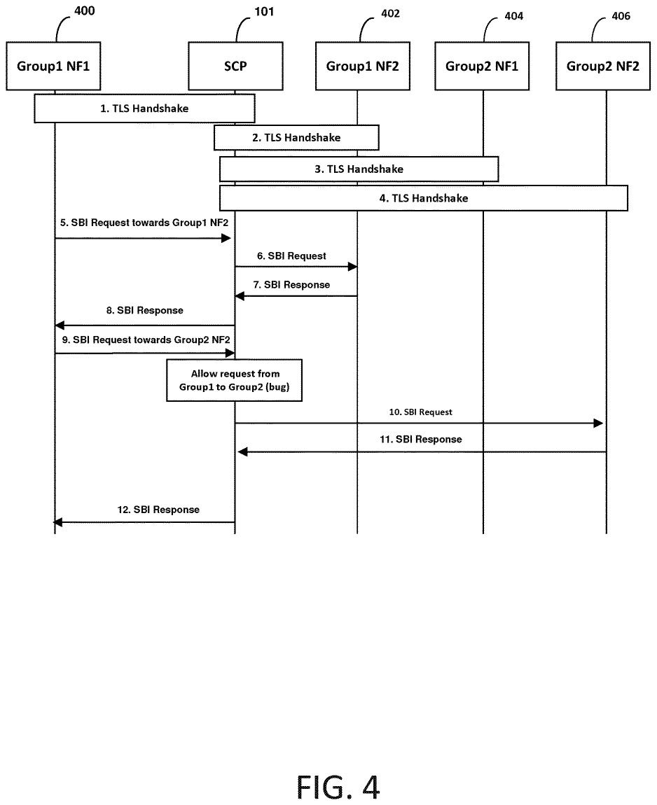

FIG. 4 is a sequence diagram showing the inability to segregate communications into trust groups when indirect routing via the SCP is utilized. Referring to FIG. 4, in steps 1-4, NFs 400, 402, 404, and 406 conduct TLS handshakes with SCP 101. In steps 5-8, an SBI request is sent by Group1 NF1 400 toward Group1 NF2 402, SCP 101 forwards the request, Group1 NF2 402 responds back to SCP 101, and SCP 101 forwards the response to Group1 NF1 400.

In steps 9-12, an SBI request is sent by Group1 NF1 400 toward Group2 NF2 406 via SCP 101, SCP 101 forwards the request (which should not be allowed), Group2 NF2 406 responds to SCP 101, and SCP 101 forwards the response to Group1 NF1 400.

### Solution

To address the problems described above, the SCP automatically assigns a security group to connected NFs based on the TLS certificate issuer learned as part of the TLS handshake. The SCP matches the consumer NF and producer NF security groups to allow communication. The security group is chosen as the issuer CA: all NFs with TLS certificates issued by the same issuer CA are part of the same security group.

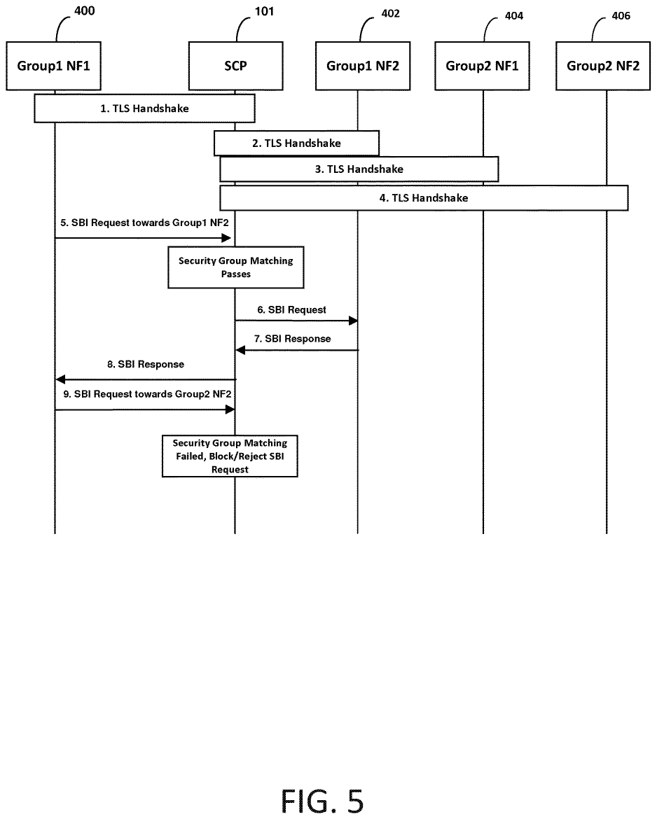

FIG. 5 is a message flow diagram illustrating the solution. Referring to FIG. 5, in steps 1-4, each of NFs 400, 402, 404, and 406 conducts a TLS handshake with SCP 101. SCP 101 reads the client certificate from TLS Certificate messages from the TLS clients (i.e., NFs 400, 402, 404, and 406) and reads the client certificate CA identifier from the client certificates. The client certificate CA identifier of each of NFs 400, 402, 404, and 406 identifies an NF security group, and SCP 101 stores each client certificate issuer CA identifier in a record in NF security group database. SCP 101 reads the identities of the trusted certificate authorities from certificate_authorities extensions of the ClientHello messages from the NFs and creates and automatically populates the records in the NF security group database with the NF instance identifiers of NF instances that are members of the same security group. Thus, an NF security group database record may include the identities of the client certificate issuer CA of each NF and any CAs that are trusted by the NF. SCP 101 may also store mappings between NF instance identifiers and CAs so that SCP 101 can determine the client certificate issuer CA of a target of an SBI request message for the purpose of determining when an SBI message sender and an SBI message recipient are members of the same NF security group. Table 2 shown below illustrates examples of security grouping database records that may be generated by SCP 101 for the NFs illustrated in FIG. 4.

TABLE 2
Examples of Auto-Populated
Security Group Database Records

| | Client | | |
|---|---|---|---|
| Member | Certificate | Trusted | Security |
| NFs | Issuer CA | CAs | Group |
| Group1_NF1, | CA1 | CA1, | Group1 |
| Group1 NF2 | | CA2 | |
| Group2 NF1 | CA3 | CA3, | Group 2 |
| Group2 NF2 | | CA4 | |

In Table 2, each row corresponds to an NF security group database record. The first row after the table header corresponds to the record for NF security Group1, and the second row after the table header corresponds to the record for NF security Group2.

Returning to FIG. 5, in step 5, Group1 NF1 400 sends an SBI request towards Group1 NF2 402. SCP 101 receives the request, reads the client certificate of NF1 400 from the request, reads the client certificate issuer CA identifier from the client certificate, uses the client certificate issuer CA identifier to perform a lookup in the NF security group database, and determines, from the lookup that the client certificate issuer CA identified by CA1 read from the request corresponds to Group1. SCP 101 also determines the NF instance ID of the target for the SBI request, uses the NF instance ID perform a lookup in the NF security group database to determine the client certificate issuer CA of the target. In this example, it is assumed that the NF instance ID of the target (Group1 NF2 402) maps to client certificate issuer CA2. SCP 101 performs a lookup in the NF security group database using CA2, determines that the request is directed towards a target NF that is in the same NF security group as the sending NF, and allows the request. In step 6, SCP 101 forwards the SBI request received from Group 1 NF1 400 toward Group1 NF2 402. In step 7, Group1 NF2 402 transmits an SBI response to SCP 101. In step 8, SCP 101 forwards the SBI response to Group1 NF1 400.

In step 9, Group1 NF 400 sends an SBI request to Group 2 NF2 406. SCP 101 reads the client certificate from the request, identifies CA1 as the client certificate issuer certificate authority, performs a lookup in the NF security group database using CA1, and determines that the sender of the SBI request is in NF security Group1. SCP 101 determines the NF instance ID of the target for the request is Group2 NF2 402, performs lookups in the NF security group database to determine that the client certificate issuer CA of Group2 NF2 406 is CA3, and CA3 corresponds to NF security Group2. Accordingly, SCP 101 determines that Group1 NF1 400 is not in the same NF security group as Group2 NF2 406, determines that the SBI request should not be allowed, and blocks or rejects the SBI request. It should be noted that the SBI request may also be allowed in instances in which Group1 NF1 400 and Group2 NF2 406 are not in the same NF security group but are in NF security groups with mutually trusted certificate authorities. Thus, using a NF security group database populated (automatically or manually) for TLS certificate authority information, an SCP can implement NF security group segregation between NFs.

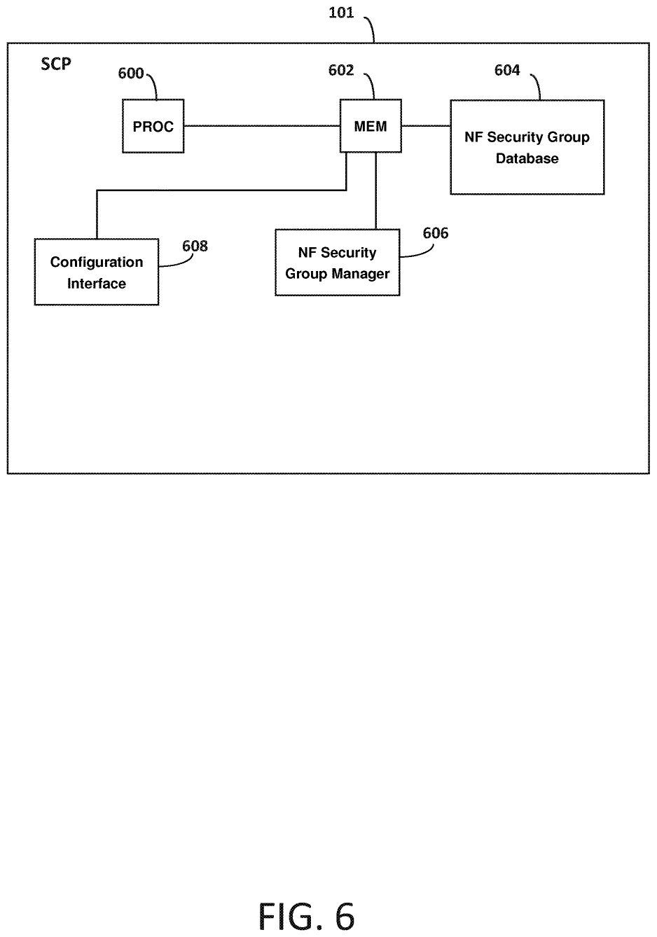

FIG. 6 is a block diagram illustrating an exemplary architecture for an SCP that implements NF security group segregation for SBI messages. In FIG. 6, SCP 101 includes at least one processor 600 and memory 602. SCP 101 further includes NF security group database 604, which may be populated by SCP 101 using TLS certificate authority messages exchanged between SCP 101 and each NF. SCP 101 also includes an NF security group manager 606 that performs the operations described herein for automatically or manually populating NF security group database 604 and using NF security group database 604 to block or allow SBI request messages among non-directly connected NFs, such as NFs managed by different MVNOs in a service provider's network. SCP 101 may further include a configuration interface 608 to allow a network operator to configure NF security group associations in NF security group database 604. NF security group manager 606 and configuration interface 608 may be implemented using computer executable instructions stored in memory 602 and executed by processor 600.

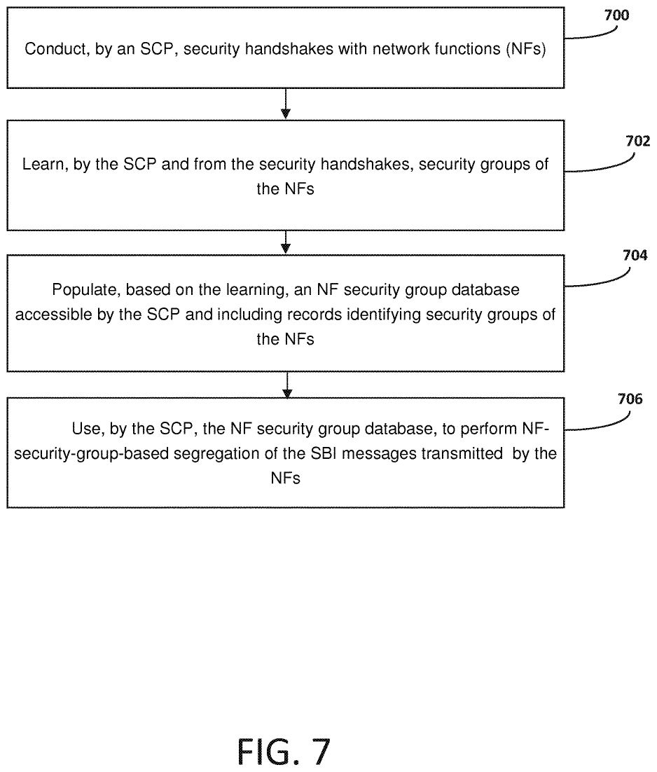

FIG. 7 is a flow chart illustrating an exemplary process for SCP-enforced network segregation. Referring to FIG. 7, in step 700, the process includes conducting, by an SCP, security handshakes with network functions (NFs). In one example, the security handshakes include TLS handshakes between SCP 101 and each of Group1 NF1 400, Group1 NF2 402, Group2 NF1 404, and Group2 NF2 406.

In step 702, the process further includes learning, by the SCP and from the security handshakes, security groups of the NFs. In one example, SCP 101 reads the client certificate issuer CAs of the client certificates of each NF from TLS Certificate messages transmitted by each NF, reads certificate authority identities of trusted CAs from a certificate_authorities extension in a TLS ClientHello message transmitted by each NF and uses the client certificate issuer CA identifier as a security group identifier for the NF.

In step 704, the process further includes populating, based on the learning, an NF security group database accessible by the SCP and including records identifying security groups of the NFs. In one example, SCP 101 creates records in NF security group database 604 associating client certificate issuer CAs and trusted CAs with security groups.

In step 706, the process further includes receiving, by the SCP, service-based interface (SBI) messages transmitted by the NFs. In one example, SCP 101 receives an SBI request from Group1 NF1 400 that identifies a target NF instance ID corresponding to Group1 NF2 402 or Group2 NF2 406.

In step 708, the process further includes using, by the SCP, the NF security group database, to perform NF-security-group-based segregation of the SBI messages transmitted by the NFs. In one example, SCP 101 performs a lookup in NF security group database 604 using the sender and target client certificate issuer CAs and forwards the SBI message when the sender and target are in the same security group (e.g., Group 1), but blocks or rejects the SBI message when the sender and target are in different security groups (e.g., Group 1 and Group 2), unless the different security groups are designated as mutually trusted.

The subject matter described herein provides network segregation to enhance security by enabling SCP 101 to restrict SBI communications based on NF security groups. The approach is extensible, for example by leveraging the TLS certificate_authorities extension (or a similar mechanism) to establish trust relationships among security groups when appropriate. The approach is also straightforward to implement, because it uses certificate authority information learned during TLS handshakes and enforcement logic at the SCP.

The disclosure of each of the following references is incorporated herein by reference in its entirety.

### REFERENCES

1. 3^{rd} Generation Partnership Project; Technical Specification Group Core Network and Terminals; 5G System; Network Function Repository Services; Stage 3 (Release 19) 3GPP TS 29.510 V19.6.0 (2026-03)
2. 3^{rd} Generation Partnership Project; Technical Specification Group Core Network and Terminals; 5G System; Technical Realization of Service Based Architecture; Stage 3 (Release 19) 3GPP TS 29.500 V19.6.0 (2026-03).
3. Rescorla, E., “The Transport Layer Security (TLS) Protocol Version 1.3”, RFC 8446, RFC Editor, August 2018, DOI: 10.17487/RFC8446.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for service communication proxy (SCP)-enforced network function (NF) security-group-based network segregation, the method comprising:
conducting, by an SCP, security handshakes with NFs;
learning, by the SCP and from the security handshakes, security groups of the NFs;
populating, based on the learning, an NF security group database accessible by the SCP and including records identifying security groups of the NFs;
receiving, by the SCP, service-based interface (SBI) messages transmitted by the NFs; and
using, by the SCP, the NF security group database, to perform security-group-based segregation of the SBI messages transmitted by the NFs.

2. The method of claim 1 wherein conducting the security handshakes with the NFs includes conducting transport layer security (TLS) security handshakes with the NFs.

3. The method of claim 2 wherein learning security groups of the NFs includes reading, from TLS Certificate messages transmitted by the NFs, client certificate issuer certificate authority (CA) identifiers and reading, from certificate_authorities extensions of TLS ClientHello messages transmitted by the NFs, lists of identifiers of CAs trusted by the NFs.

4. The method of claim 3 wherein populating the security group database comprises including, in each record of the NF security group database, an identifier of a client certificate issuer CA and identifiers of CAs trusted by the NFs.

5. The method of claim 1 wherein populating the security group database includes automatically populating the security group database by the SCP.

6. The method of claim 1 wherein populating the security group database includes manually populating the security group database through a configuration interface of the SCP.

7. The method of claim 1 wherein using the NF security group database to perform security-group-based segregation of the SBI messages transmitted by the NFs includes:
receiving an SBI message;
determining a client certificate issuer certificate authority (CA) identifier of a sender of the SBI message, a client certificate issuer CA identifier of a target of the SBI message;
using the client certificate issuer CA identifier of the sender or the client certificate CA identifier of the target to locate a record in the security group database;
determining using the record, whether the sender and the target are members of the same NF security group.

8. The method of claim 7 comprising, in response to determining that sender and the target are members of the same NF security group, forwarding the SBI message to the target.

9. The method of claim 7 comprising, in response to determining that the sender and the target are not members of the same NF security group, blocking the SBI message.

10. The method of claim 7 comprising, in response to determining that the sender and the target are not members of the same NF security group but are members of mutually trusted security groups, forwarding the SBI message.

11. A system for service communication proxy (SCP)-enforced network function (NF)-security-group-based network segregation, the system comprising:
an SCP including at least one processor and memory;
an NF security group manager stored in the memory and executable by the at least one processor for learning, from security handshakes between the SCP and NFs, security groups of the NFs; populating, based on the learning, an NF security group database accessible by the SCP and including records identifying security groups of the NFs; receiving service-based interface (SBI) messages transmitted by the NFs; and using the NF security group database to perform security-group-based segregation of the SBI messages transmitted by the NFs.

12. The system of claim 11 wherein the security handshakes comprise transport layer security (TLS) security handshakes.

13. The system of claim 12 wherein the NF security group manager is configured to learn the NF security groups of the NFs by reading, from TLS Certificate messages transmitted by the NFs, client certificate issuer certificate authority (CA) identifiers and reading, from a certificate_authorities extension of TLS ClientHello messages transmitted by the NFs, lists of identifiers of certificate authorities trusted by the NFs.

14. The system of claim 13 wherein the NF security group manager is configured to include, in each record of the NF security group database, an identifier of a client certificate issuer CA and identifiers of CAs trusted by the NFs.

15. The system of claim 11 wherein the NF security group manager is configured to automatically populate the NF security group database.

16. The system of claim 11 wherein the SCP includes a configuration interface for manually populating the NF security group database.

17. The system of claim 11 wherein the NF security group manager is configured to use the NF security group database to perform security-group-based segregation of the SBI messages transmitted by the NFs by:
receiving an SBI message;
determining a client certificate issuer certificate authority (CA) identifier of a sender of the SBI message and a client certificate issuer CA identifier of a target of the SBI message;
using the client certificate issuer CA identifier of the sender or the client certificate issuer CA identifier of the target to locate a record in the NF security group database; and
determining, using the record, whether the sender and the target are members of the same NF security group.

18. The system of claim 17 wherein the NF security group manager is configured to, in response to determining that the sender and the target are members of the same NF security group, cause the SCP to forward the SBI message to the target.

19. The system of claim 17 wherein the NF security group manager is configured to, in response to determining that the sender and the target are not members of the same NF security group, cause the SCP to block the SBI message.

20. A non-transitory computer readable medium having stored thereon computer executable instructions that, when executed by at least one processor of a service communication proxy (SCP), cause the SCP to:
conduct security handshakes with network functions (NFs); learn, from the security handshakes, security groups of the NFs;
populate, based on the learning, an NF security group database accessible by the SCP and including records identifying security groups of the NFs;
receive service-based interface (SBI) messages transmitted by the NFs; and
use the NF security group database to perform security-group-based segregation of the SBI messages transmitted by the NFs.
